(19) United States
(12) Patent Application Publication
(10) Pub. No.: US 2025/0047627 A1
(43) Pub. Date: Feb. 6, 2025

(54) INTELLIGENT SYSTEM FOR IMPROVING DISPLAY AND RECOGNITION IN MESSAGE STREAMING

(71) Applicant: Workato, Inc., Mountain View, CA (US)

(72) Inventors: Nikhil Venkatesh, Dublin, CA (US); Nishtha Mehrotra, Northville, MI (US)

(21) Appl. No.: 18/793,370

(22) Filed: Aug. 2, 2024

Related U.S. Application Data
(60) Provisional application No. 63/517,295, filed on Aug. 2, 2023.

(51) Int. Cl. H04L 51/21; G06F 3/0481; G06F 40/103; H04L 51/02

(52) U.S. Cl. CPC H04L 51/21; G06F 3/0481; G06F 40/103; H04L 51/02

(57) ABSTRACT

A system may provide a conversational graphical user interface for displaying messages between a user and another party. The system may determine that a first message from the other party is in a streaming state, which indicates that the first message is streaming to the user in the conversational graphical user interface. The system may display the first message in a first message format based on the first message being in the streaming state, determine that the first message from the other party is in a complete state, and may display the first message from the other party in a second message format based on the first message being in the complete state.

### BACKGROUND

The present disclosure relates to a customizable platform for improving display and recognition in message streaming. For instance, the disclosure relates to tracking and improving graphical interface animations in chat interfaces.

Using text to chat between humans and customer service agents, chat bots (e.g., artificial intelligence bots or large language models), or other parties may be used to allow access to information and improve customer service. In some instances, a chat style interface may transmit entire messages between parties, which may be displayed in chat bubbles that appear all at once in a chat interface. Unfortunately, as longer messages may take up more than an entire display, especially on small-screen devices, users may need to scroll upwards and then back down again to read an entire received message.

Recently chat interfaces, especially from chat bots, use message streaming to display messages as they are received or generated. In some instances, message streaming may appear as though a sending user is typing lines or individual letters on a chat interface.

Unfortunately, dynamic streamed messages or content introduces visual jitter because a bubble needs to adjust its width and height to accommodate new content being continuously streamed.

Additionally, with slower responses or network connections, users are not sure when the chat message has completed streaming since there is no differentiation between the states when a message is being streamed and when it is completely streamed.

During conversations between humans, people rely on a combination of verbal (e.g., tone, pauses) and non-verbal (e.g., body language) to infer when one person is done speaking and is ready to listen for a response. Unfortunately, the ability to recognize when a person or chat bot is done speaking is greatly diminished in text-based digital communication since graphical interfaces lack intuitive visual cues, which issues are exacerbated in a conversation with an Al agent since these agents may generate content much faster than humans can think, and do not pause streaming for conversational purposes; although, they might pause due to network issues, rate limits, or other technical limitations.

Accordingly, because streamed message blocks vary in length and cause visual jitter and may grow their widths or blocks at unpredictable or uneven intervals, and because it is difficult to ascertain the end of a streamed message, an improved system is needed to communicate the state of streamed messages and improve their usability and appearance.

### SUMMARY

This disclosure describes technology that addresses the above-noted deficiencies of existing solutions by providing technology for improving conversational graphical interfaces, among other improvements. In some aspects, the techniques described herein relate to a computer-implemented method including: providing, by one or more processors, a conversational graphical user interface for displaying messages between a user and another party; determining, by the one or more processors, that a first message from the other party is in a streaming state, the streaming state indicating that the first message is streaming to the user in the conversational graphical user interface; displaying, by the one or more processors, the first message being streamed in a first message format based on the first message being in the streaming state; determining, by the one or more processors, that the first message from the other party is in a complete state; and displaying, by the one or more processors, the first message from the other party in a second message format based on the first message being in the complete state.

In some aspects, the techniques described herein relate to a computer-implemented method, further including: determining, by the one or more processors, one or more previously completed messages from the other party in the complete state; and displaying, by the one or more processors in the conversational graphical user interface, the one or more previously completed messages from the other party in the first message format based on the one or more previously completed messages from the other party being in the complete state.

In some aspects, the techniques described herein relate to a computer-implemented method, further including: receiving, by the one or more processors, a first chat message from the user via the conversational graphical user interface; and relaying, by the one or more processors, the first chat message to the other party, the other party including an artificial intelligence chat bot.

In some aspects, the techniques described herein relate to a computer-implemented method, further including: determining, by the one or more processors, a starting position in the conversational graphical user interface for the first message from the other party, the starting position indicating one or more of a first horizontal and a first vertical position for the first message in the conversational graphical user interface; and determining, by the one or more processors, an ending position in the conversational graphical user interface for the first message, the ending position indicating one or more of a second horizontal and a second vertical position in the conversational graphical user interface corresponding to a maximum size of a message area from the other party.

In some aspects, the techniques described herein relate to a computer-implemented method, further including: providing, by the one or more processors, the message area in the conversational graphical user interface for the first message, the message area being visually defined from a background of the conversational graphical user interface at the starting position and being visually less defined from the background of the conversational graphical user interface at the ending position.

In some aspects, the techniques described herein relate to a computer-implemented method, wherein: the ending position changes as the first message is streamed and a dimension of the message area is based on the ending position in the conversational graphical user interface for the first message; and the method includes increasing, by the one or more processors, a size of the message area in the conversational graphical user interface based on the starting position and the ending position as the first message is displayed.

In some aspects, the techniques described herein relate to a computer-implemented method, wherein the first message format for the streaming state includes: a contrast of the message area relative to a background of the conversational graphical user interface varying in a gradient between a first portion of the message area adjacent to the starting position and a second portion of the message area adjacent to the ending position; and the message area including a border between the message area and the background adjacent to the starting position and no border between the message area and the background adjacent to the ending position before a completion time.

In some aspects, the techniques described herein relate to a computer-implemented method, wherein: the first message format for the first message in the streaming state includes: a visible border along a left edge distinguishing a message area for the first message from a background of the conversational graphical user interface, an invisible border along a right edge of the message area, and a background of the message area along the right edge of the message area that matches the background of the conversational graphical user interface; and the second message format for the first message in the complete state includes: a visible border enclosing a perimeter of the message area, and the background of the message area being visually distinguished from the background of the conversational graphical user interface.

In some aspects, the techniques described herein relate to a computer-implemented method, further including: determining, by the one or more processors, a completion time at which an end of the first message is displayed in the conversational graphical user interface; and at the completion time, updating, by the one or more processors, the conversational graphical user interface to increase contrast between a message area of the first message and a background of the conversational graphical user interface.

In some aspects, the techniques described herein relate to a computer-implemented method, further including: providing, by the one or more processors, an input area in the conversational graphical user interface, the input area being configured to receive a user input from the user when the first message is in the complete state.

In some aspects, the techniques described herein relate to a computer-implemented method, further including: modifying, by the one or more processors, a visual format of the input area when the first message is in the streaming state including reducing a contrast of the input area from a background of the conversational graphical user interface.

In some aspects, the techniques described herein relate to a computer-implemented method, further including: preventing, by the one or more processors, text input from being entered into the input area when the first message is in the streaming state.

In some aspects, the techniques described herein relate to a computer-implemented method, further including: after displaying the first message in the second message format based on the first message being in the complete state, modifying, by the one or more processors, a visual attribute of an input area of the conversational graphical user interface, the visual attribute including an appearance of a border of the input area.

In some aspects, the techniques described herein relate to a computer-implemented method, wherein: the streaming state of the first message indicates that a portion of the first message is displayed pending display of a remainder of the first message.

In some aspects, the techniques described herein relate to a system including: one or more processors; and a non-transitory computer memory storing instructions that, when executed by the one or more processors cause the system to perform operations including: providing a conversational graphical user interface for displaying messages between a user and an other party; determining that a first message from the other party is in a streaming state, the streaming state indicating that the first message is streaming to the user in the conversational graphical user interface; displaying the first message being streamed in a first message format based on the first message being in the streaming state; determining that the first message from the other party is in a complete state; and displaying the first message from the other party in a second message format based on the first message being in the complete state.

In some aspects, the techniques described herein relate to a system, wherein the operations further include: determining one or more previously completed messages from the other party in the complete state; and displaying, in the conversational graphical user interface, the one or more previously completed messages from the other party in the first message format based on the one or more previously completed messages from the other party being in the complete state.

In some aspects, the techniques described herein relate to a system, wherein the operations further include: providing, by the one or more processors, a message area in the conversational graphical user interface for the first message, the message area being visually defined from a background of the conversational graphical user interface at a left edge and being visually less defined from the background of the conversational graphical user interface at a right edge.

In some aspects, the techniques described herein relate to a system, wherein the first message format for the streaming state includes: a contrast of a message area for the first message relative to a background of the conversational graphical user interface varying in a gradient between a first portion of the message area and a second portion of the message area; and the message area including a border between the message area and the background adjacent to the first portion and no border between the message area and the background adjacent to the second portion before a completion time.

In some aspects, the techniques described herein relate to a system, wherein the operations further include: determining, by the one or more processors, a completion time at which an end of the first message is displayed in the conversational graphical user interface; and at the completion time, updating, by the one or more processors, the conversational graphical user interface to increase contrast between a message area of the first message and a background of the conversational graphical user interface.

In some aspects, the techniques described herein relate to a system, wherein the operations further include: providing, by the one or more processors, an input area in the conversational graphical user interface, the input area being configured to receive a user input from the user when the first message is in the complete state; modifying, by the one or more processors, a visual format of the input area when the first message is in the streaming state including reducing a contrast of the input area from a background of the conversational graphical user interface; and preventing, by the one or more processors, text input from being entered into the input area when the first message is in the streaming state.

Other implementations of one or more of these aspects or other aspects include corresponding systems, apparatus, and computer programs, configured to perform the various actions and/or store various data described in association with these aspects. These and other implementations, such as various data structures, are encoded on tangible computer storage devices. Numerous additional features may, in some cases, be included in these and various other implementations, as discussed throughout this disclosure. It should be understood that the language used in the present disclosure has been principally selected for readability and instructional purposes, and not to limit the scope of the subject matter disclosed herein.

### BRIEF DESCRIPTION OF THE DRAWINGS

The patent or application file contains at least one drawing executed in color. Copies of this patent or patent publication with color drawing(s) will be provided by the Office upon request and payment of the necessary fee.

This disclosure is illustrated by way of example, and not by way of limitation in the figures of the accompanying drawings in which like reference numerals are used to refer to similar elements.

FIG. 1 is a block diagram illustrating an example integration management system encompassed by the technology.

FIG. 2 is a block diagram of an example computing system.

FIG. 3 is a flowchart depicting an example method for intelligently improving conversational graphical user interfaces.

FIG. 4 is a flowchart depicting an example method for improving display recognition in message streaming.

FIGS. 5A and 5B illustrate an example conversational graphical user interface in which messages are interchanged between a user and another party and transform between a streaming and complete state.

FIGS. 6A-6H illustrate a series of interfaces showing a choreography of a message changing states, for example, from streaming to completed.

FIGS. 7A and 7B illustrate example graphical user interfaces including a code section and a chat section.

### DETAILED DESCRIPTION

The innovative technology disclosed in this application is capable of, for instance, providing an intelligent system that improves interactions in chat interfaces for improving display of recognition in message streaming. These technologies improve message streaming from other users or chat bots through improved graphical interfaces, animation, and coordination of graphical elements, among other improvements and techniques.

In some instances, the technologies may use animation to guide artificial intelligence message streaming on a display, for example, where artificial intelligence copilots are Al-powered chat interfaces that are available in different parts of an application's experience. Users can interact with the copilot to create programmatic assets such as software connectors and recipes. Copilots take input from the users, ask clarifying questions, and may generate large pieces of text as a response. These pieces of content can be lists (when confirming the outline of assets it will create), or blocks of code (when creating parts of connectors using a connector SDK). The technologies here in provide a new chat interface that includes streaming responses from an Al copilot, for instance, as opposed to traditional chat interfaces that send complete messages at once.

For example, for typical chat interfaces before Al chat became mainstream, messages were between people, or between a person and pre-programmed bots. In this chat interface paradigm, messages would be sent to the other party only after the entire message was ready. Messages that showed up on the interface were always complete, which means that the interface elements that displayed the message were always fixed in size and the message within them did not change dynamically. With Al chat interfaces, this paradigm changed. Message responses from an Al bot may be displayed to the user as they are being generated. In some implementations, the contents of the response are shown to the other party as soon as it begins generating, and content is added on in a sequence, which may be referred to as message streaming.

When creating an interface with a chat style interface using bubbles to display messages, dynamic streamed content introduces a visual jitter because the bubble needs to adjust its width and height to accommodate new content being continuously streamed. Additionally, with slower responses or network connections, users are not sure when the chat message has completed streaming since there is no differentiation between the states when a message is being streamed and when it has completed streaming.

The technology may address these, and other problems listed above, with visual design and/or motion design to create a smooth and improved experience for users in a streaming interface, such as when interacting with our chat bots. To recreate the effect of non-verbal communication in chat interfaces, especially with chat bots or Al agents, the technology may use a combination of visual and motion design.

The technology may use various techniques, which are described in further detail throughout this disclosure, such as differentiating streaming in-progress and completed states for Al agent generated messages; using motion to choreograph conversational flow to replicate non-verbal cues; using visual styling to reduce visual jitter during message streaming; and/or using motion and visual contrast to replicate non-verbal cues when communicating with an Al agent.

In some implementations, the technology may be applied with a cloud-based service that automates interaction between different applications (e.g., software or web applications) to facilitate data flow, and integrates data from among the different applications based on customizable criteria. For example, the technology may be implemented in a conversational interface that allows users to work with multiple distributed applications, humans, chat bots, or otherwise. For example, the technology may allow a user to interact with a large language model or other Al agent (also referred to herein as a chat bot) that generates or facilitates generation of software recipe. A recipe may be an integration flow that includes a trigger and a set of actions. The user may interact with chat bot directly or via another service, such as a chat application or other conversational interface to receive notifications and/or execute commands respective to various applications. It should be noted that although the chat messages described herein are referred to in the context of a chat bot, implementations may be used in other chat interactions.

With reference to the figures, reference numbers may be used to refer to components found in any of the figures, regardless of whether those reference numbers are shown in the figures being described. Further, where a reference number includes a letter referring to one of multiple similar components (e.g., component 000a, 000b, and 000n), the reference number may be used without the letter to refer to one or all of the similar components.

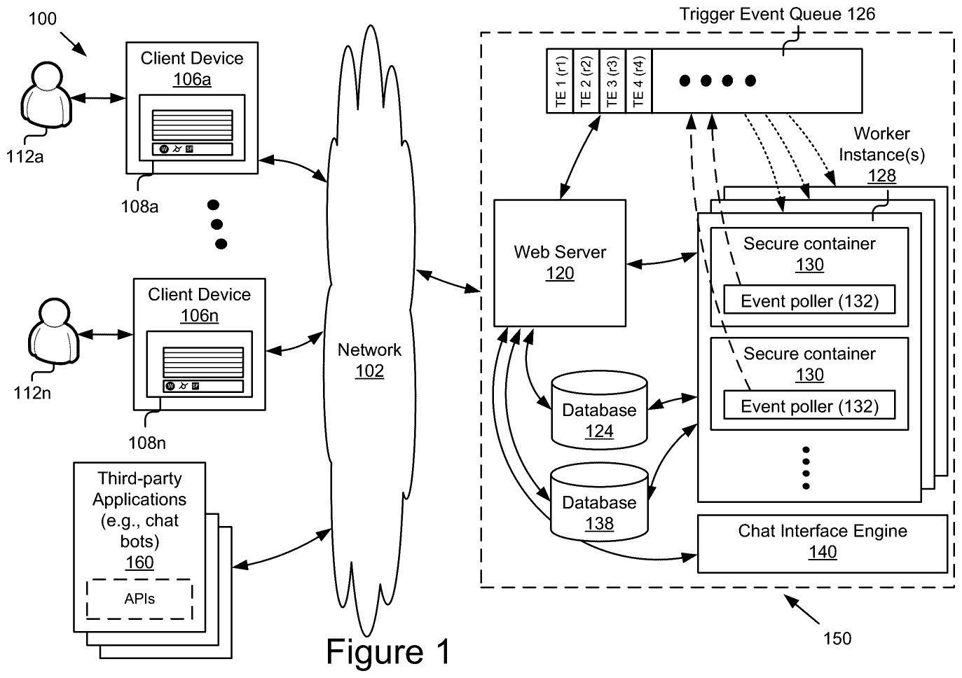

FIG. 1 is a block diagram illustrating an example system 100 in which the technology may be used. The illustrated example system 100 includes client devices 106a . . . 106n, a server system 150, and third-party applications 160, which are communicatively coupled via a network 102 for interaction with one another. For example, the client devices 106a . . . 106n may be respectively coupled to the network 102 and may be accessible by users 112a . . . 112n (also referred to individually and collectively as 112). The server system 150 and third-party applications 160 may be communicatively coupled to the network 102. The use of the nomenclature “a” and “n” in the reference numbers indicates that any number of those elements having that nomenclature may be included in the system 100. The architecture, location of services, and other features are described by way of example.

The network 102 may include any number of networks and/or network types. For example, the network 102 may include, but is not limited to, one or more local area networks (LANs), wide area networks (WANs) (e.g., the Internet), virtual private networks (VPNs), mobile (cellular) networks, wireless wide area network (WWANs), WiMAX® networks, Bluetooth® communication networks, peer-to-peer networks, other interconnected data paths across which multiple devices may communicate, various combinations thereof, etc. Data transmitted by the network 102 may include packetized data (e.g., Internet Protocol (IP) data packets) that is routed to designated computing devices coupled to the network 102. In some implementations, the network 102 may include a combination of wired and wireless networking software and/or hardware that interconnects the computing devices of the system 100. For example, the network 102 may include packet-switching devices that route the data packets to the various computing devices based on information included in a header of the data packets.

The client devices 106a . . . 106n (also referred to individually and collectively as 106) include computing systems having data processing and communication capabilities. In some implementations, a client device 106 may include a processor (e.g., virtual, physical, etc.), a memory, a power source, a network interface, and/or other software and/or hardware components, such as a display, graphics processor, wireless transceivers, keyboard, camera, sensors, firmware, operating systems, drivers, and/or various physical connection interfaces (e.g., USB, HDMI, etc.), etc. The client devices 106a . . . 106n may couple to and communicate with one another and the other entities of the system 100 via the network 102 using a wireless and/or wired connection.

Examples of client devices 106 may include, but are not limited to, mobile phones (e.g., feature phones, smart phones, etc.), tablets, laptops, desktops, netbooks, server appliances, servers, virtual machines, TVs, set-top boxes, media streaming devices, portable media players, navigation devices, personal digital assistants, etc. While two or more client devices 106 are depicted in FIG. 1, the system 100 may include any number of client devices 106. In addition, the client devices 106a . . . 106n may be the same or different types of computing systems.

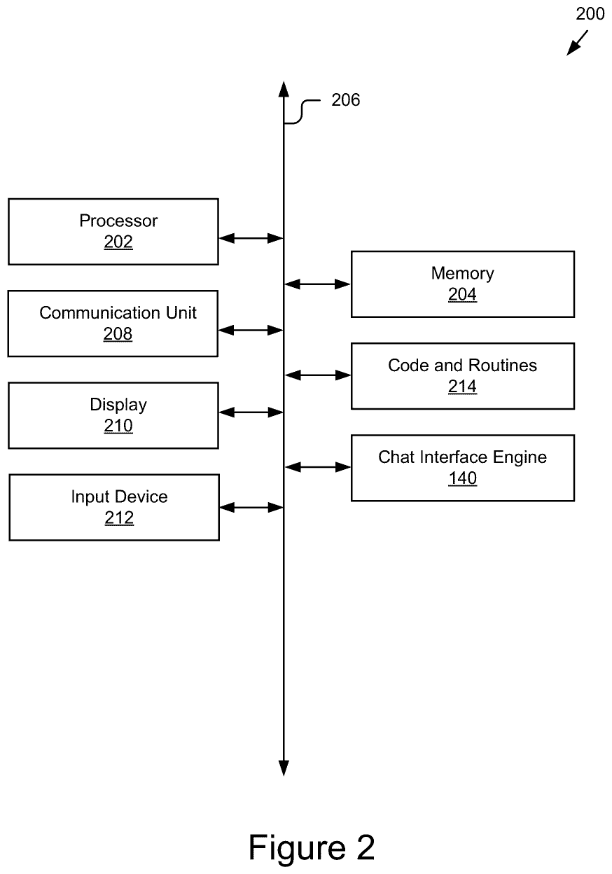

In the depicted implementation, the client devices 106a . . . 106n respectively contain instances 108a . . . 108n of a client application (also referred to individually and collectively as 108). The client application 108 may be storable in a memory (e.g., see FIG. 2) and executable by a processor (e.g., see FIG. 2) of a client device 106 to provide for user interaction, receive user input, present information to the user via a display (e.g., see FIG. 2), and send data to and receive data from the other entities of the system 100 via the network 102. Examples of various interfaces that can be rendered and presented by the client application 108 are depicted herein. In some implementations, the client application 108 may present or interact with a chat application or conversational interface operable on a third-party server (not shown) and/or on the server system 150.

In some implementations, the client application 108 may generate and present various user interfaces to perform these acts and/or functionality, such as the example graphical user interfaces discussed elsewhere herein, which may, in some cases, be based at least in part on information received from local storage, the server system 150, and/or one or more of the third-party applications 160 via the network 102.

In some implementations, the client application 108 is code operable in a web browser, a native application (e.g., mobile app), a combination of both, etc. Additional structure, acts, and/or functionality of the client devices 106 and the client application 108 are described in further detail elsewhere in this document.

In some implementations, the client application 108 may include or communicate with the chat interface engine 140, as described in further detail below. For instance, the client application 108 may incorporate some or all of the functionality described in reference to the chat interface engine 140.

The server system 150, a third-party server (not shown), and/or the third-party applications 160 may include one or more computing systems having data processing, storing, and communication capabilities. For example, these entities 150 and/or 160 may include one or more hardware servers, virtual servers, server arrays, storage devices and/or systems, etc., and/or may be centralized or distributed/cloud-based. In some implementations, these entities 150 and/or 160 may include one or more virtual servers, which operate in a host server environment and access the physical hardware of the host server including, for example, a processor, memory, storage, network interfaces, etc., via an abstraction layer (e.g., a virtual machine manager).

In the depicted implementation, the server system 150 includes a web server 120, a trigger event queue 126, databases 124 and 138, worker instances 128, and a chat interface engine 140. These components, and their sub-components, are coupled for electronic communication with one another, and/or the other elements of the system 100. In some instances, these components may communicate via direct electronic connections or via a public and/or private computer network, such as the network 102.

In some embodiments, a worker instance 128 represents a worker compute node and may include more than one secure container 130, as shown in FIG. 1. A container in the worker instance 128, at a given time, may run a recipe. A container may add trigger events to the trigger event queue 126 and (responsive to the trigger event being triggered) receive events from the trigger event queue 126. The event poller 132 is software configured to poll for messages indicating the completion of a prior call so the secure container can proceed to the next step of the recipe (or to completion as the case may be). The server system 150 may utilize any suitable runtime environment and process queue/worker architecture, such as Heroku™.

The web server 120 includes computer logic executable by the processor 202 (see FIG. 2) to process content requests. The web server 120 may include an HTTP server, a REST (representational state transfer) service, or other suitable server type. The web server 120 may receive content requests (e.g., product search requests, HTTP requests, commands, etc.) from client devices 106, cooperate with the other components of the server system 150 (e.g., chat interface engine 140, worker instances 128, trigger event queue 126, etc.) to determine the content and or trigger processing, retrieve and incorporate data from the databases 124 and 138, format the content, and provide the content to the client devices 106. In some instances, the web server 120 may format the content using a web language and provide the content to a corresponding client application 108 for processing and/or rendering to the user for display. The web server 120 may be coupled to the databases 124 and 138 to store retrieve, and/or manipulate data stored therein.

In some embodiments, the components 108, 120, 128, 126, and/or 140 may include computer logic storable in the memory 204 and executable by the processor 202, and/or implemented in hardware (e.g., ASIC, FPGA, ASSP, SoC, etc.), to provide their acts and/or functionality. For example, with reference also to FIG. 2, in some embodiments, the client application 108, the web server 120, the worker instances 128, the trigger event queue 126, and/or the chat interface engine 140, and/or their sub-modules are sets of instructions executable by the processor 202 to provide their functionality. In some embodiments, these components and/or their sub-components are stored in the memory 204 of the computing system 200 and are accessible and executable by the processor 202 to provide their functionality. In any of the foregoing embodiments, these components and/or their sub-components may be adapted for cooperation and communication with the processor 202 and other components of the computing system 200.

The databases 124 and 138 are information sources for storing and providing access to data. Examples of the types of data stored by the databases 124 and 138 may include user and partner account information, codes representing the recipes, requirement tables associated with the codes, input and output schemas associated with the codes and/or applications, event data, metadata, objects associated with the applications, codes, and/or schemas, etc., and/or any of the other data discussed herein that is received, processed, stored, or provided by the integration management system 100. Recipes may be associated with a user's account.

The databases 124 and 138 may be included in the computing system 200 or in another computing system and/or storage system distinct from but coupled to or accessible by the computing system 200. The databases 124 and 138 can include one or more non-transitory computer-readable mediums for storing the data. In some implementations, the databases 124 and 138 may be incorporated with the memory 204 or may be distinct therefrom. In some implementations, the databases 124 and 138 may include a database management system (DBMS) operable on the computing system 200. For example, the DBMS could include a structured query language (SQL) DBMS, a NoSQL DBMS, various combinations thereof, etc. In some instances, the DBMS may store data in multi-dimensional tables comprised of rows and columns, and manipulate, i.e., insert, query, update and/or delete, rows of data using programmatic operations.

The third-party applications 160a . . . 160n, as depicted, may respectively expose APIs 162 for accessing the functionality and data of the third-party applications 160a . . . 160n (also referred to individually and collectively as 160). An application 160 may include hardware (e.g., a server) configured to execute software, logic, and/or routines to provide various services (consumer, business, etc.), such as video, music and multimedia hosting, distribution, and sharing; email; social networking; blogging; micro-blogging; photo management; cloud-based data storage and sharing; ERM; CRM; financial services; surveys; marketing; analytics; a combination of one or more of the foregoing services; or any other service where users store, retrieve, collaborate, generate, consume, and/or share information.

In some implementations, the third-party applications 160 may include messaging services, artificial intelligence models, chat bots, or other services.

In some implementations, the client application 108, the various components of the server system 150, the third-party applications 160, etc., may require users 112 to be registered to access the acts and/or functionality provided by them. For example, to access various acts and/or functionality provided by these components, the components may require a user 112 to authenticate his/her identity (e.g., by confirming a valid electronic address or other information). In some instances, these entities 108, 120, 140, 160, etc., may interact with a federated identity server (not shown) to register/authenticate users 112. Once registered, these entities may require a user 112 seeking access to authenticate by inputting credentials in an associated user interface.

The system 100 illustrated in FIG. 1 may be representative of an example system for collaborative design, and it should be understood that a variety of different system environments and configurations are contemplated and are within the scope of the present disclosure. For instance, various functionality may be moved from a server to a client, or vice versa and some implementations may include additional or fewer computing systems, services, and/or networks, and may implement various functionality client or server-side. Further, various entities of the system 100 may be integrated into a single computing device or system or additional computing devices or systems, etc.

Additional acts, structure, and/or functionality of at least the client devices 106, the server system 150, the third-party applications 160, and their constituent components are described in further detail below.

FIG. 2 is a block diagram of an example computing system 200. The example computing system 200 may represent the computer architecture of a client device 106, a server system 150, a server of a conversational interface application, and/or a server of the third-party application 160, depending on the implementation. As depicted, the computing system 200 may include a processor 202, a memory 204, a communication unit 208, a display 210, and an input device 212, which may be communicatively coupled by a communications bus 206. The computing system 200 depicted in FIG. 2 is provided by way of example and it should be understood that it may take other forms and include additional or fewer components without departing from the scope of the present disclosure. For instance, various components of the computing devices and may be coupled for communication using a variety of communication protocols and/or technologies including, for instance, communication buses, software communication mechanisms, computer networks, etc.

The processor 202 may execute software instructions by performing various input/output, logical, and/or mathematical operations. The processor 202 may have various computing architectures to process data signals including, for example, a complex instruction set computer (CISC) architecture, a reduced instruction set computer (RISC) architecture, and/or an architecture implementing a combination of instruction sets. The processor 202 may be physical and/or virtual, and may include a single core or plurality of processing units and/or cores. In some implementations, the processor 202 may be capable of generating and providing electronic display signals to a display device, supporting the display of images, capturing and transmitting images, performing complex tasks including various types of feature extraction and sampling, etc. In some implementations, the processor 202 may be coupled to the memory 204 via the bus 206 to access data and instructions therefrom and store data therein. The bus 206 may couple the processor 202 to the other components of the computing system 200 including, for example, the memory 204, the communication unit 208, display 210, and the input device 212.

The memory 204 may store and provide access to data to the other components of the computing system 200. The memory 204 may be included in a single computing device or a plurality of computing devices as discussed elsewhere herein. In some implementations, the memory 204 may store instructions and/or data that may be executed by the processor 202. For example, the memory 204 may include various different combinations of the software components described herein, depending on the configuration. The memory 204 is also capable of storing other instructions and data, including, for example, an operating system, hardware drivers, other software applications, databases, etc. The memory 204 may be coupled to the bus 206 for communication with the processor 202 and the various other components of computing system 200.

The memory 204 includes a non-transitory computer-usable (e.g., readable, writeable, etc.) medium, which can be any tangible apparatus or device that can contain, store, communicate, propagate or transport instructions, data, computer programs, software, code, routines, etc., for processing by or in connection with the processor 202. In some implementations, the memory 204 may include one or more of volatile memory and non-volatile memory. For example, the memory 204 may include, but is not limited, to one or more of a dynamic random access memory (DRAM) device, a static random access memory (SRAM) device, a discrete memory device (e.g., a PROM, FPROM, ROM), a hard disk drive, an optical disk drive (CD, DVD, Blue-ray™, etc.). It should be understood that the memory 204 may be a single device or may include multiple types of devices and configurations.

The bus 206 can include a communication bus for transferring data between components of a computing system or between computing systems, a network bus system including the network 102 and/or portions thereof, a processor mesh, a combination thereof, etc. In some implementations, the various components of the system 100 may cooperate and communicate via a software communication mechanism implemented in association with the bus 206. The software communication mechanism can include and/or facilitate, for example, inter-process communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

The communication unit 208 may include one or more interface devices (I/F) for wired and/or wireless connectivity with the network 102 and/or other computing systems. For instance, the communication unit 208 may include, but is not limited to, CAT-type interfaces; wireless transceivers for sending and receiving signals using Wi-Fi™, Bluetooth®, IrDA™, Z-Wave™, ZigBee®, cellular communications, and the like, etc.; USB interfaces; various combinations thereof; etc. The communication unit 208 may connect to and send/receive data via a mobile network, a public IP network of the network 102, a private IP network of the network 102 etc. In some implementations, the communication unit 208 can link the processor 202 to the network 102, which may in turn be coupled to other processing systems. The communication unit 208 can provide other connections to the network 102 and to other entities of the system 100 using various standard network communication protocols, including, for example, those discussed elsewhere herein.

The display 210 may display electronic images and data output by the computing system 200 for presentation to a user 112. The display 210 may include any conventional display device, monitor or screen, including, for example, an organic light-emitting diode (OLED) display, a liquid crystal display (LCD), etc. In some implementations, the display 210 may be a touchscreen display capable of receiving input from one or more fingers of a user 112. For example, the display 210 may be a capacitive touchscreen display capable of detecting and interpreting multiple points of contact with the display surface. In some implementations, the computing system 200 may include a graphics adapter (not shown) for rendering and outputting the images and data for presentation on display 210. The graphics adapter (not shown) may be a separate processing device including a separate processor and memory (not shown) or may be integrated with the processor 202 and memory 204.

The input device 212 may include any device for inputting information into the computing system 200. In some implementations, the input device 212 may include one or more peripheral devices. For example, the input device 212 may include a keyboard (e.g., a QWERTY keyboard), a pointing device (e.g., a mouse or touchpad), microphone, an image/video capture device (e.g., camera), etc. In some implementations, the input device 212 may include a touchscreen display capable of receiving input from the one or more fingers of the user. For instance, the structure and/or functionality of the input device 212 and the display 210 may be integrated, and a user of the computing system 200 may interact with the computing system 200 by contacting a surface of the display 210 using one or more fingers. In this example, the user could interact with an emulated (i.e., virtual or soft) keyboard displayed on the touchscreen display 210 by using fingers to contact the display in the keyboard regions.

A recipe is an integration flow that contains a trigger and a set of actions. The trigger causes the actions in a recipe to be executed. Actions are the routines the recipe runs. Each action may include an input configuration and is associated with a given application (e.g., a third-party application 160). Each trigger and action may further include metadata, such as an input schema and an output schema. Actions may run in parallel, series, or various combinations thereof. In some instances, one action may be dependent upon the output of a preceding action. In a typical recipe configuration, the different actions in the recipe are associated with different applications, and the recipe automates the interaction between the different applications using the application programming interfaces (APIs) of those applications. For instance, the recipe may flow, sync, etc., data from one application to another, populate multiple different applications with data from a certain source application, etc. In some embodiments, the recipes are written in Ruby, and the secure containers 130 of the worker instances 128 interpret and process the recipes, although it should be understood that other languages and interpreters may be used.

In some implementations, one or more modules or engines, such as a chat interface engine 140, code and routines 214, or components may be included and may include computer logic storable in the memory 204 and executable by the processor 202, and/or implemented in hardware to provide its acts and/or functionality, such as the description herein. Other code and routines 214 may be used to provide other communication and functionality of the computing device 200.

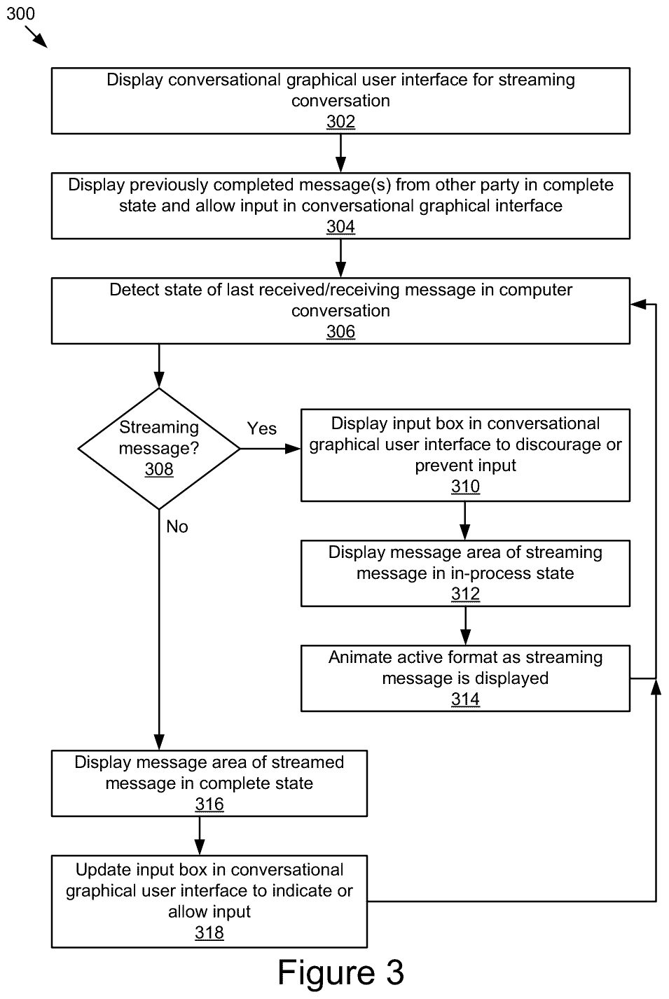

FIG. 3 is a flowchart depicting an example method 300 for intelligently improving conversational graphical user interfaces, for example, for message streaming between a user and another party, such as a large language model that streams messages. It should be noted that although this method and other methods and functionality described herein may be described as being performed by a chat interface engine 140, the operations and functionality may be executed on different and/or distributed devices.

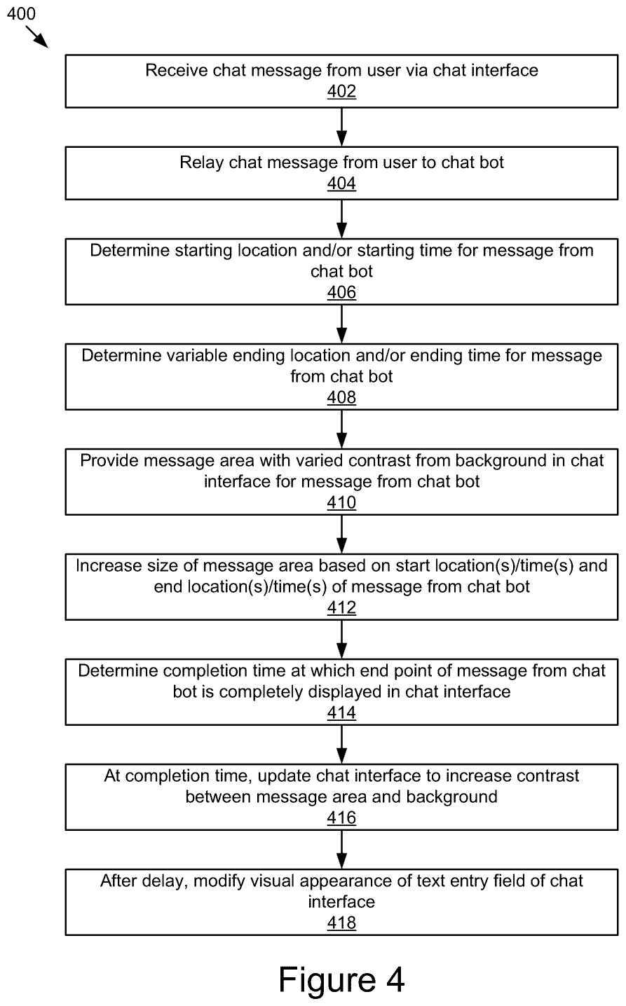

For instance, as described elsewhere herein, the chat interface engine 140 may include or interface with a large language model, other artificial intelligence service, or other conversational bot to send textual messages to or receive textual messages therefrom. Although an interface with an LLM chat bot is described herein, other implementations are possible and contemplated, such as where messages are streamed, received, or displayed over time. Additional operations, features, devices, and details for the operations of the method 300 are described elsewhere herein, such as in reference to FIG. 4, the graphical user interfaces, and elsewhere.

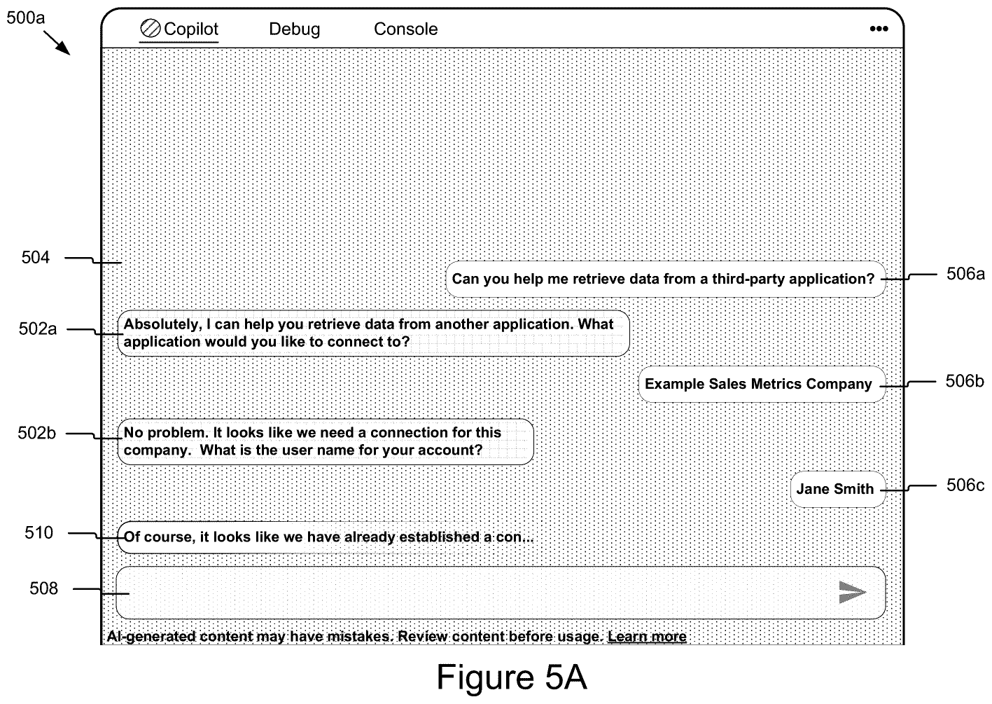

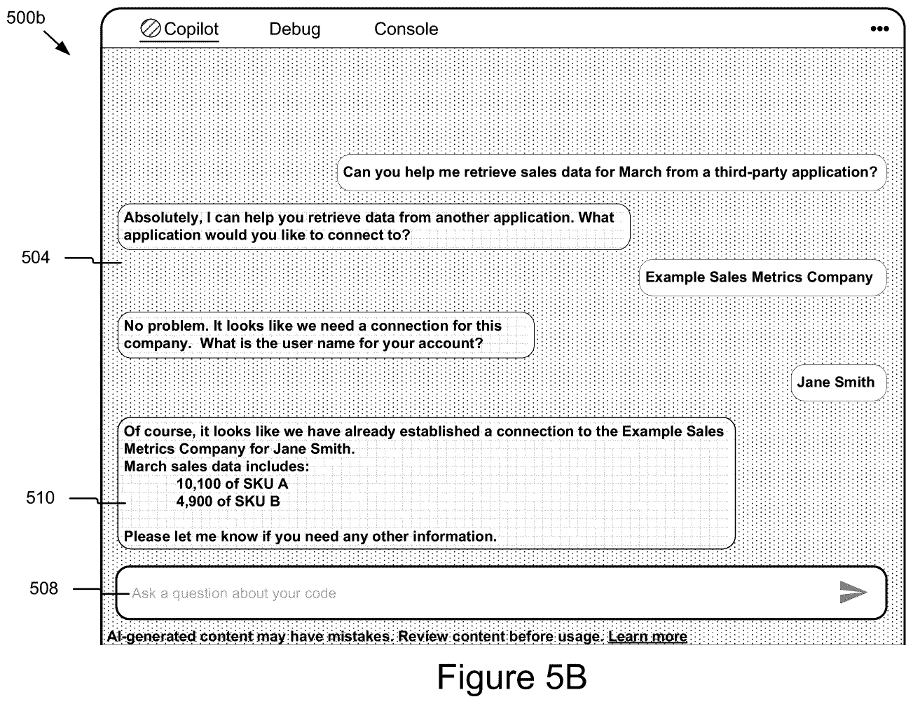

In some implementations, at 302, the chat interface engine 140 may display a graphical user interface for streaming messages. For example, the chat interface engine 140 may provide a conversational graphical user interface (also referred to herein as a chat interface) for displaying messages between a user and another party. A conversational graphical user interface may have various formats in which a message is received from another party. For instance, it may include text bubbles between a user and another party, along with an input box via which a user may provide input. It may have various improvements, such as those described below and in reference FIGS. 5A-7B.

In some implementations, at 304, the chat interface engine 140 may display previously completed message(s) from the other party in a complete state and/or allow input in conversational graphical interface. For example, as noted in reference to FIGS. 5A and 5B, previous messages by a user or another party may be displayed in the conversational interface(s) and, the chat interface engine 140 may determine one or more previously completed text messages from the other party in one or more completed states. For instance, the completed state(s) may indicate that a previous message is no longer editable, no longer being edited, no longer streaming, or a similar completed message.

In some implementations, the chat interface engine 140 may display, in the conversational graphical user interface, the one or more previously completed messages from the other party in the first message format based on the one or more previously completed messages from the other party being in the complete state(s). For instance, the format for the completed state may clearly indicate that the messages are complete. In some instances, messages from the user may also be displayed in a completed or other format.

For example, as illustrated, each of the previously completed messages may be displayed in a format that clearly distinguishes the completed messages from a background of the chat interface. In some instances, this format may include a first background color and/or pattern. Additionally, or alternatively, the completed format may include a border bounding the chat message(s), such as a chat bubble that distinguishes the messages from each other and/or from the background. Additional example details and implementations are described elsewhere herein.

In some implementations, at 306, the chat interface engine 140 may detect a state of last received/receiving message in computer conversation. For example, the chat interface engine 140 may determine that a message is currently being received, generated, or displayed from another party. Streaming messages may be used as an artificial intelligence model generates or sends a message, or they may be used as another party types a message. A streaming message may include a message that is displayed to a user in an incomplete state, and which is updated (e.g., with each character, word, several words, etc.) until it is complete. As noted in the Background and elsewhere, typical message streaming results in visual jitter, inconsistent responses, confusion, bandwidth issues, incorrect responses to and by an Al model, or other issues. The operations described herein address the issues through improved operations, graphical interface features, animations, and other features.

In some implementations, at 308, the chat interface engine 140 may determine whether the message from the other party is streaming, for example, separately or in combination with the operation at 308. For example, the chat interface engine 140 may determine that a first message from the other party is in a streaming state, the streaming state indicating that the first message is streaming to the user in the conversational graphical user interface. In some instances, this determination may be based on whether an end marker of a message was received, whether the engine has finished displaying a message, or another means of determining that it is complete.

In some implementations, at 310, the chat interface engine 140 may display an input box, area, or field in conversational graphical user interface to discourage or prevent input from the user while the message is streaming from the other party.

For example, the chat interface engine 140 may modify a visual format of the input area when the first message is in the streaming state including reducing a contrast of the input area from a background of the conversational graphical user interface, changing the border, or otherwise. In some implementations, the chat interface engine 140 may additionally or alternatively prevent text or other input from being entered into the input area by the user when the first message is in a streaming state. For instance, these and other features are described in further detail in reference to the examples of FIGS. 4-7B.

In some implementations, at 312, the chat interface engine 140 may display the streaming message in in-process state. For instance, it may display the first message being streamed in a first message format based on the first message being in the streaming state. Various formats may be used to indicate the streaming state, including those described in further detail throughout this disclosure, such as in reference to FIGS. 4-7B below.

Depending on the implementation, the format for the streaming message/message in a streaming state may include reduced contrast between the message and a background of the chat interface, which provides a visual cue to the user indicating when the streaming is active or complete.

For example, because a computer-based conversation lacks visual cues for when to speak that are common in face-to-face conversations, the technologies herein provide graphical indications that indicate to the user that the message is still streaming. The issues with knowing when a received communication is complete are exacerbated when a message is streamed over the internet, where context for the message is missing and issues with latency, bandwidth, push frequency, etc., vary the amount of time between display of parts (e.g., characters, words, etc.) of a message, so it can be very difficult for the user to know when the message is complete. Furthermore, when the other party is an Al chat bot (e.g., an LLM), variations in processing time, especially when the chat bot is providing workflows, code, search data, etc., can vary wildly and it can be difficult to know when the streaming message is complete or frozen.

Accordingly, implementations of the technology provided herein may provide various visual indications that the message has transitioned from a streaming state to a complete state. Examples of these are described in further detail throughout this disclosure.

As noted in the Background, previous chat interfaces included text bubbles with a length that depends on the length of the message. These text bubbles have a contrasting background and/or border that distinguishes them from a background of the interfaces. If these types of text bubbles were to be used for a streaming message, they would provide significant jitter or shifting in the appearance or lighting of the display, for example, as each character, word, etc., is streamed in chunks the bubbles increase in size in corresponding jumps. This disjointed expansion is both visually uncomfortable and may worsen the other issues with streaming message, as noted above.

Accordingly, in some implementations of the technology herein, the background and/or border of a message in a streaming state/actively being streamed may be reduced in contrast (e.g., partially, completely, or as a gradient) to the background of the chat interface to hide the expansion of the message area as the message is streamed. In some instances, a left edge, border, and/or background of the message area may be contrasting or distinguished from a background of the chat interface while a right edge, border, and/or background may be minimally distinguished or undistinguished from the background of the chat interface when the message is in a streaming state. For example, while other implementations are possible, the background and/or border may have a gradient between a distinguished and undistinguished appearance that moves from a left to right and/or diagonal (e.g., down to the right) orientation.

In some implementations, at 314, the chat interface engine 140 may animate the active or first format of the message area as the streaming message is streamed/displayed. For example, the chat interface engine 140 may determine right-most edge, a bottom-most edge, a corner, or other ending position of the message area for the streaming message, which changes as the first message is streamed. The chat interface engine 140 may increase a dimension of the message area based on the ending position in the chat interface for the streaming message. For instance, the chat interface engine 140 may increase the size of the message area in the chat interface based on the starting position and the ending positioning as the first message is displayed. In some instances, where the right and/or bottom edge of the message is omitted, invisible, or low contrast from the chat interface background, the visible and/or invisible/low contrast portions of the border and/or background of the message area may resize. For instance, as the text (or other information) in the streaming message is displayed over time, the message area of the streaming message may resize to match. The contrast of the message area (whether entirely, the right edge, etc.) is limited, the expansion of the box is hidden or downplayed, as discussed elsewhere herein.

In some implementations, the chat interface engine 140 may return to 306 or otherwise detect that the streaming of the message has completed and/or that the message is now in a complete state.

In some implementations, at 316, the chat interface engine 140 may display the message area of the streamed message in a complete state. For example, the chat interface engine 140 may display the first message from the other party in a second message format based on the first message being in the complete state. In some implementations, the second message format for a complete message may have increased contrast from the first message format for a streaming message. For instance, a transition to the second format may cause a background of the message area to increase in contrast from the background of the chat interface and/or cause the border of the message to be displayed, filled in, or increased (e.g., thickened, darkened, displayed, or otherwise).

In some implementations, the chat interface engine 140 may determine a completion time at which an end of the first message is displayed in the conversational graphical user interface. The chat interface engine 140 may, at the completion time, update the conversational graphical user interface to increase contrast between a message area of the first message and a background of the conversational graphical user interface, as described in additional detail elsewhere herein.

In some implementations, at 318, the chat interface engine 140 may update the input area or box in the conversational graphical user interface to indicate or allow input by the user. For example, the input area may include a text input box via which a user may input a chat message that is sent, using the chat interface engine 140, to the other party. In some instances, the input area may receive other or additional types of input, such as media, image, audio, or otherwise.

In some implementations, the chat interface engine 140 updates the format and/or functionality of the input area based on the status of the streaming message (e.g., whether it is currently streaming or complete) and/or other factors. In some implementations, the input area may be grayed out, have lower contrast, lack a border, lack call-to-action text, or otherwise have a first format when the message is in a streaming state. In some implementations, the input area may have an increased contrast in its background and/or border, may have call-to-action text (e.g., “Enter text here” or “Ask a question about your code”) or another format that distinguishes it as being active.

In some implementations, the input area may be disabled or enabled depending on the state of the streaming message. For instance, the chat interface engine 140 may not allow input in the input area while the message is streaming and allow input to the input area when the message is complete.

In some implementations, the one or more of the transitions of the input area format may be synchronous or asynchronous with those of the most recent received/stream/streaming message from the other party (and/or may remain unchanged as a user sends messages). For instance, when a streaming message is initially received, it may be in a streaming state and, at the same time, the input area may synchronously be formatted to indicate to not receive input or to prevent input. Similarly, when a streaming message transitions to a complete state, at the same time, the chat interface engine 140 may emphasize or enable the input area, or the chat interface engine 140 may enable input area after (immediately or after a defined delay) the input area after the transition by the message to the complete state.

For example, the chat interface engine 140 may provide an input area in the conversational graphical user interface, the input area being configured to receive a user input from the user when the first message is in the complete state. In some instances, the chat interface engine 140 may, after displaying the first message in the second message format based on the second message being based on the first message being in the complete state, modify a visual attribute of an input area of the conversational graphical user interface, the visual attribute including an appearance of a border of the input area. These and other example implementations and features are described elsewhere herein.

FIG. 4 is a flowchart depicting an example method 400 for providing an intelligent system for improving display recognition in message streaming. For example, the method may provide various operations for differentiating streaming in-progress and completed states for Al generated messages; using motion to choreograph conversational flow, for example, to replicate non-verbal cues; using visual styling to reduce visual jitter during message streaming; and/or using motion and visual contrast to replicate non-verbal cues when communicating with an Al agent. It should be noted that these operations and benefits are provided as examples and in an example order. Other sequences, operations, and features may be used without departing from the scope of this disclosure.

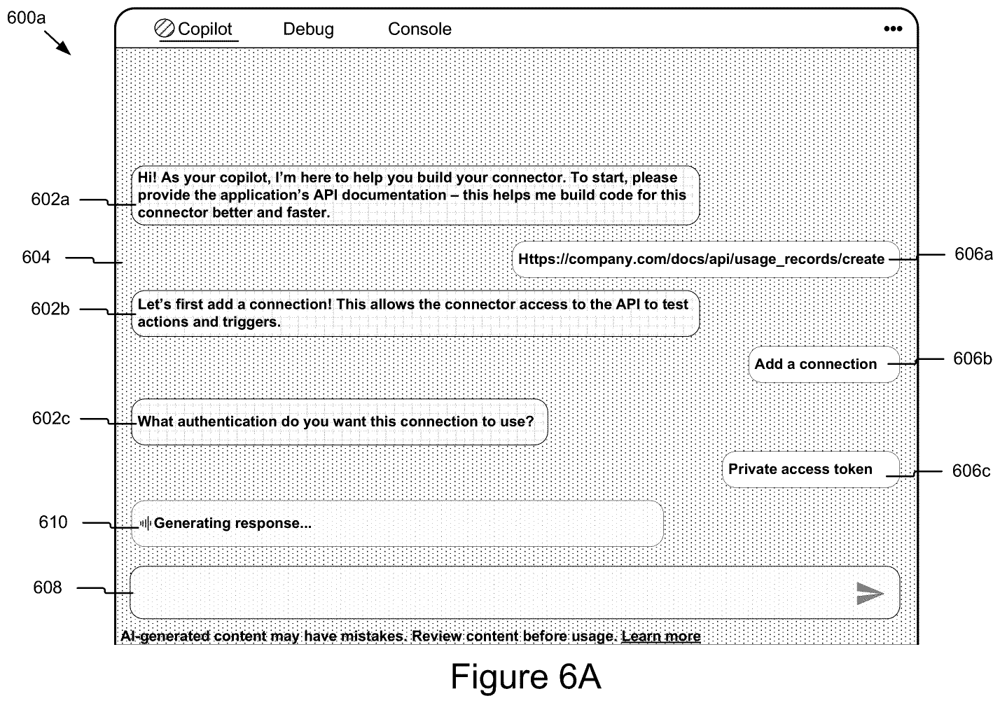

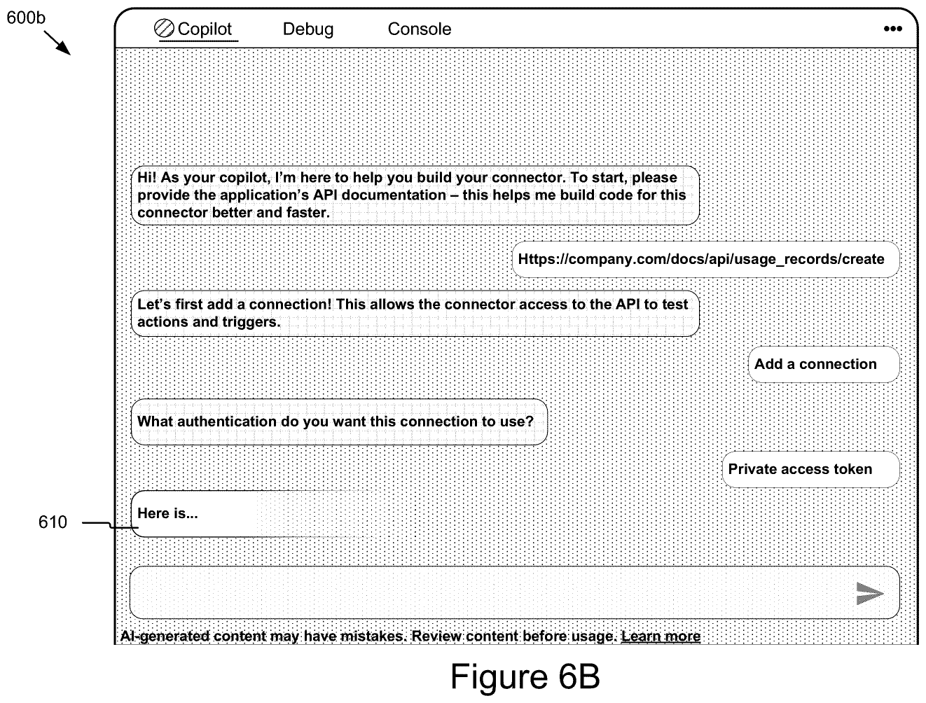

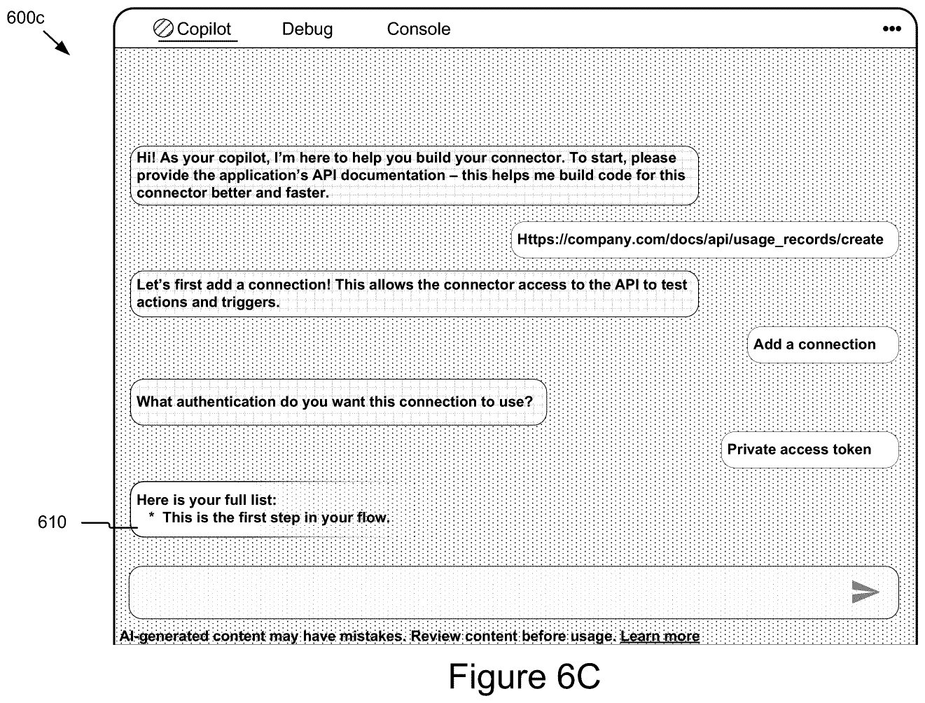

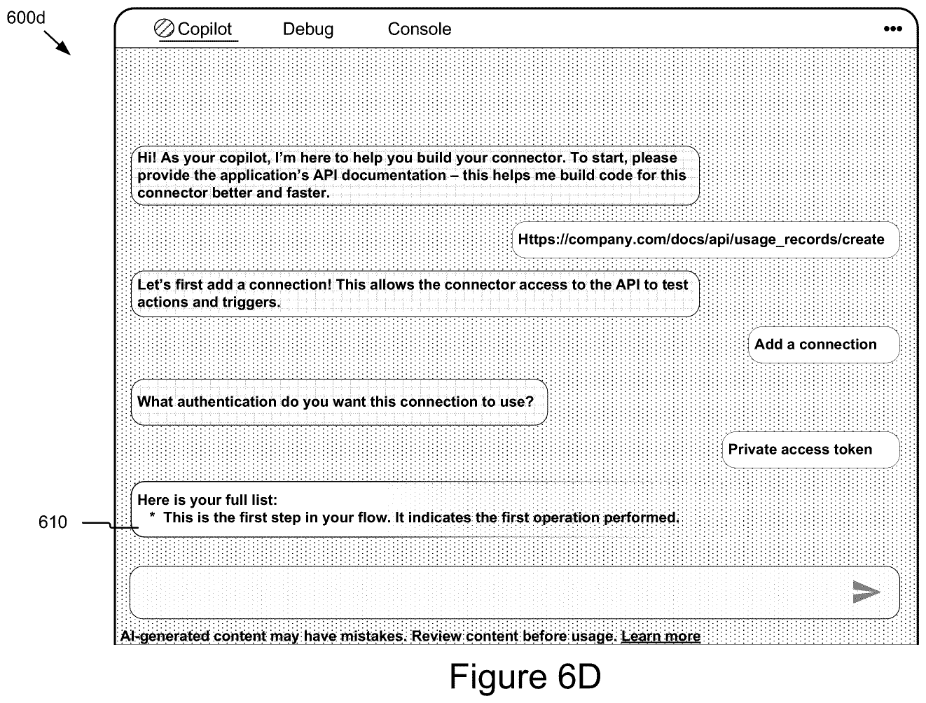

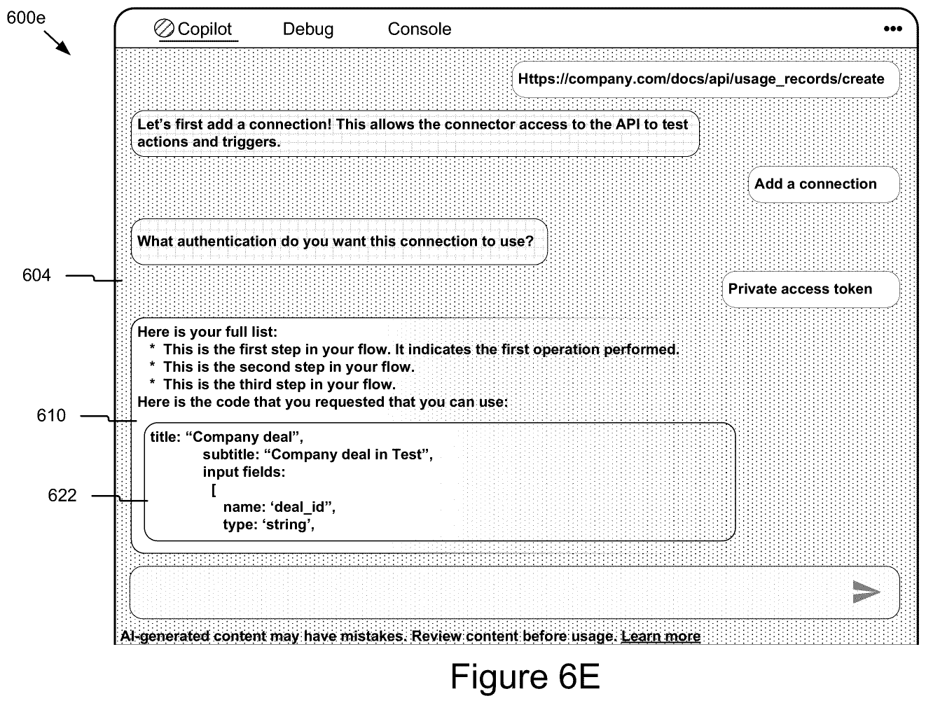

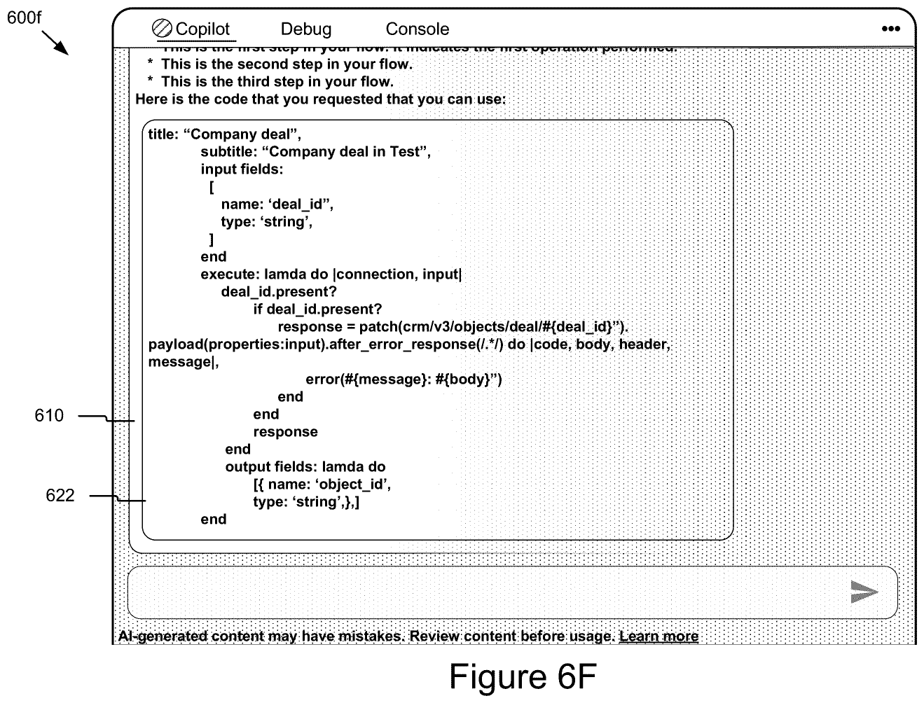

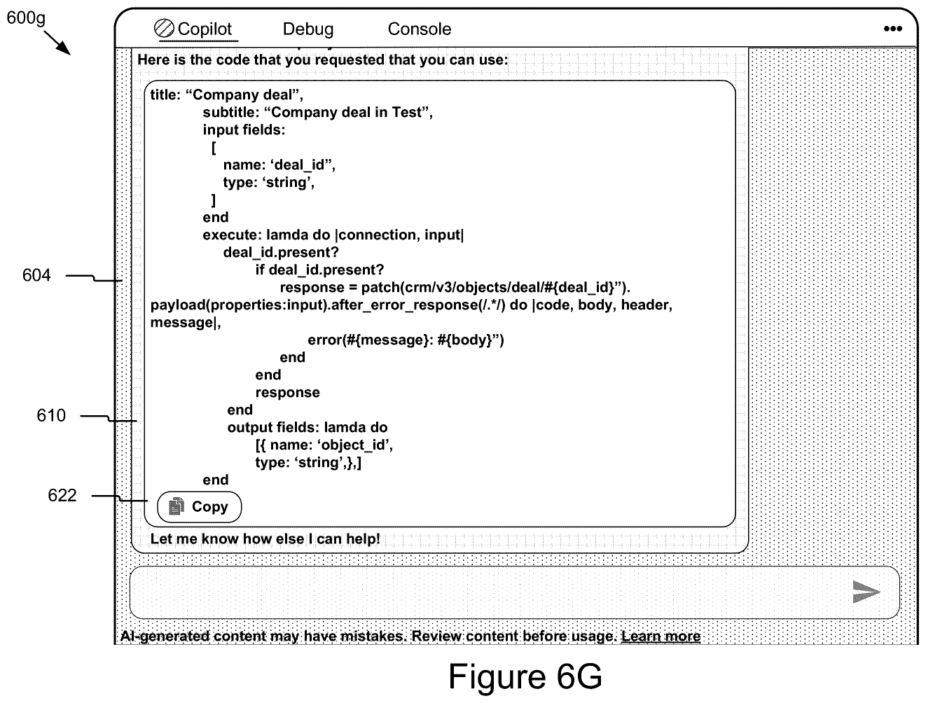

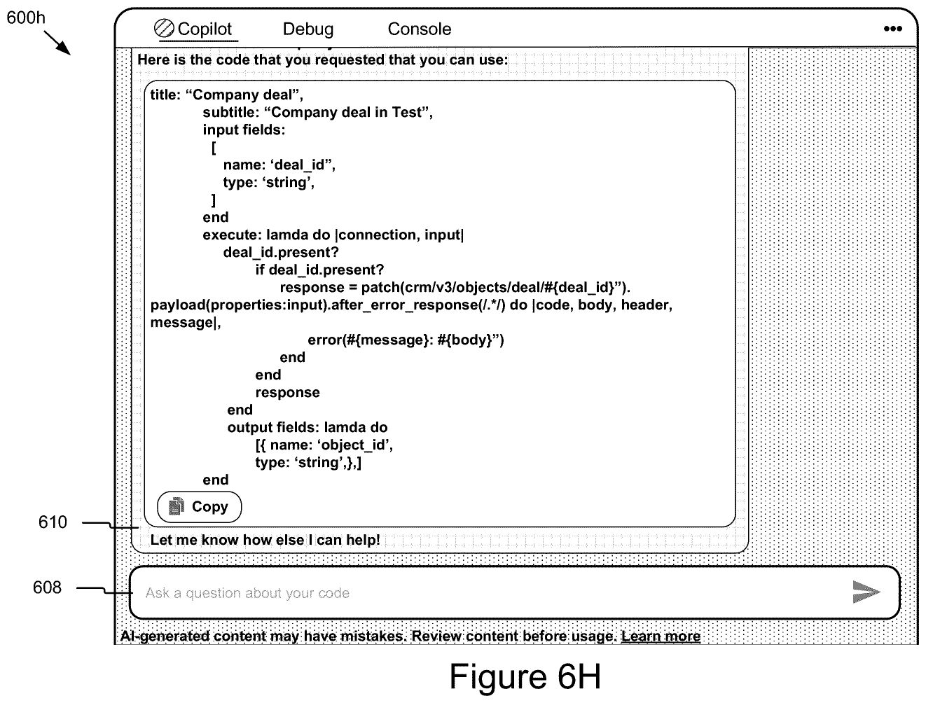

The operations of the method 400 may be augmented or described in further detail in reference to the operations and features of the other figures and description herein. For instance, an example set of graphical interfaces are shown and described below in reference to FIGS. 6A-6H.

At 402, the chat interface engine 140 may receive a first chat message from a user via a chat interface. For example, as illustrated in the example graphical interfaces of FIGS. 5A-7B in which a user sends a first message to a chat bot.

At 404, the chat interface engine 140 may relay the first chat message to a chat bot, such as an Al agent. For example, in implementations where the chat bot is implemented in a different system, the chat interface engine 140 may send the message from the user to the chat bot. Although a chat bot is described, other implementations are possible and contemplated herein, as noted elsewhere. As noted above, the chat may be with another human, and other features or implementations are possible. In some implementations, the messages may be transmitted and/or received over the Internet or may be streamed from a local model or otherwise.

At 406, the chat interface engine 140 may determine a start point for a message from the chat bot (also referred to herein as a “bot message”); although, other chat messages may also be used with the features herein. For example, the start point may include one or more of a starting time and a starting position for the bot message in the interface. The starting position may indicate one or more of a first horizontal and a first vertical position for the bot message in the chat interface. The starting time may indicate a first time at which the bot message is first displayed on the chat interface.

At 408, the chat interface engine 140 may determine an end point for the bot message from the chat bot. The end point may include one or more of an ending time and an ending position in the chat interface. The ending time may indicate a second time at which an end of the bot message is displayed on the chat interface. The ending position may indicate one or more of a second horizontal and a second vertical position in the chat interface corresponding to a maximum size of the message from the chat bot. For example, for a streaming message, the end point may vary as the message from the chat bot is generated, received, and/or displayed on the chat interface.

At 410, the chat interface engine 140 may provide a message area (e.g., a graphical element in the chat interface defining an area in the interface for a received message) in the chat interface for the bot message. Depending on the implementation, the message area may be visually defined from a background of the chat interface at the starting position and less visually defined from the background of the chat interface at the ending position.

In some implementations, the message area may include a border between the message area and the background adjacent to the starting position. In some implementations, the message area may include no border, or a more subtle border, between the message area and the background adjacent to the ending position before the completion time.

In some implementations, a contrast of the message area relative to the background of the chat interface varies in a gradient between a first portion of the message area adjacent to the starting position and a second portion of the message area adjacent to the ending position before the completion time.

In some implementations, updating the chat interface to increase contrast between the message area and the background of the chat interface at the completion time includes providing, in the chat interface, a border, or a more-defined border, between the message area and the background adjacent to the ending position at the completion time.

As illustrated in FIGS. 5A-7B, the reply message from the chat bot may be in a boxed area or message area in a chat interface. In some implementations, while the bot message is in an active state (e.g., being actively generated, received, and/or displayed), the message area may have a background that is a contrasting color, pattern, or darkness to that of the background of the chat interface. The background may vary in contrast from a starting point/position (e.g., a top and/or left) to a right and/or bottom edge, for example, so that it fades into the background.

In some implementations, the message area may include a border around some or all of it in order to separate it from the background of the chat interface. As illustrated, the border may be defined at a starting point/position (e.g., at a top and/or left). In some implementations, the border may be hidden, undefined, subtle, or otherwise changed at points further from the starting point (e.g., near an ending point/position at a right and/or bottom of the message area). This change may be defined as a gradient.

As noted above, these features may reduce the jumps in how a message area is displayed and/or expands, so that these jitters or jumps appear to be smooth. Additionally, this provides an indication that the message has not yet been completely generated, received, and/or displayed.

At 412, the chat interface engine 140 may increase a size of the message area in the chat interface based on the starting position and the ending position including updating the size of the message area as the ending position varies.

In some implementations, the message area may display parts of the area before other parts of the message, such as in message streaming. In such instances, the message area may increase in horizontal and/or vertical dimensions to accommodate the message as it is streamed (e.g., generated, received, and/or displayed).

At 414, the chat interface engine 140 may determine a completion time at which an end of the bot message is displayed in the chat interface, for example, where the message has been completely generated, received, and/or displayed.

At 416, the chat interface engine 140 may, at the completion time, update the chat interface to increase contrast between the message area and the background of the chat interface.

At 418, the chat interface engine 140 may, after a defined delay from the completion time, modify a visual attribute of a text-entry field of the chat interface, for example, it may modify the appearance of text-entry graphical element in the chat interface. For example, in some implementations, a defined delay may be programmed to emphasize that both the bot message is complete and that it is now possible or suggested for a user to enter a message or ask a question about the bot message.

FIGS. 5A and 5B illustrate an example conversational graphical user interface in which messages are interchanged between a user and another party, such as an LLM chat bot. For instance, the messages received or displayed from the other party may be streamed into one of multiple message areas in the interface. FIGS. 5A and 5B are provided by way of example and other implementations described herein are possible.

FIG. 5A illustrates a graphical user interface 500a, which displays two previously completed message areas 502a and 502b for messages in a completed state from another party. As illustrated, each of the completed message areas 502a and 502b include continuous borders and a first background, which is distinguished from the background 504 of the chat interface. While patterns are illustrated in FIG. 5A (e.g., due to the limitations of line drawings), colors, gradients, color depth, etc., may be additionally or alternatively used.

FIG. 5A also illustrates three messages 506a, 506b, and 506c from the user. The user messages 506 may have a different color, border, background, position, or other format that distinguishes them from the messages from the other party.

FIG. 5A illustrates an input area or box 508 for receiving user messages. As described in further detail above and as illustrated in FIG. 5A, an input area 508 may have a thinner border, be transparent, be grayed out, or otherwise be deemphasized when a streaming message 510 is in a streaming state. In some implementations, the input area 508 may be deactivated when the streaming message 510 is in a streaming state.

The message area 510 for a message being streamed (whether received or displayed) from another user is also shown. In the example, a border of the area 510 may be well-defined or visible at a left edge and may transition (e.g., in a gradient) to being lower contrast, invisible, or transparent toward a right edge (and/or bottom edge), so that its expansion is hidden or deemphasized as the message is streamed/expands.

Additionally, or alternatively, in some implementations, the message area 510 in FIG. 5A may have a background that is well-defined from the background 504 at a left edge and transition (e.g., in a gradient) to match the background 504 at a right edge and/or a bottom edge. In some implementations, the entire background/fill of the message area 510 matches or is similar to the background 504. In some instances, the format may also affect the color, size, boldness, etc., of a font.

As described in further detail above, the message area 510 may expand visibly (e.g., in the border or background) or invisibly (e.g., without changing the border or background) as the message is streamed. This expansion may be vertical and/or horizontal.

For example, the format for the message area 510 in the streaming state may include a visible border along a left edge distinguishing a message area 510 for the most-recent streaming message from a background of the conversational graphical user interface, an invisible border along a right edge of the message area 510, and a background of the message area 510 along the right edge of the message area 510 that matches the background 504 of the conversational graphical user interface 500.

FIG. 5B illustrates a graphical user interface 500b in which the message in the message area 510 has transitioned from a streaming state to a completed state. For instance, once the message area 510 is complete, the chat interface engine 140 may add, complete, or fill out its border, thicken the border, change the border color, and/or otherwise differentiate it from the background 504. In some implementations, the chat interface engine 140 may additionally or alternatively change the background of the message area 510 to differentiate it from the background 504 of the chat interface. For example, the color, pattern, darkness, gradient, transparency, or other attribute may be modified to distinguish it from the background 504.

As described in further detail below, a message area 510 may include an internal box (not shown in FIG. 5A or 5B) that displays information, such as generated code. The chat interface engine 140 may also update the border and/or background of the internal box to differentiate it from one or both of the background 504 and the message area 510. For instance, where a chat bot is generating and/or displaying additional media (e.g., a software recipe or code), an additional box may be displayed within the message area for the additional media. This additional box may have some features of the message area, such as the changing and/or varied background and/or border.

As illustrated, format for the message area 510, when in the completed state, may include a visible border enclosing a perimeter of the message area 510, and the background of the message area 510 being visually distinguished from the background 504 of the conversational graphical user interface 500.

FIGS. 6A-6H also illustrate a chat interface(s) 600a-600h in which a message area 610 is increased in size vertically and horizontally as a message is streamed. As noted in reference to FIGS. 5A and 5B, the interface(s) 600 may also display previous, completed messages from the user and/or the other party.

The figures and features herein illustrate an example combination of visual modes for chat messages, such as those from an Al bot that is/are in a waiting state, are currently being streamed, or have completed streaming.

The example technology may solve the visual jitter problem by the choice of styling used. For instance, using a low-contrast background, the technology may take away focus from a chat bubble background and redirect it to the contents of the message. The reduced contrast reduces the visual jitter that was previously created due to the contrast between a bubble background and the window background.

In some implementations, the technology may add a subtle border to the message currently being streamed. Adding this border along the left edge in the same color scheme as other AI messages creates a visual link between all Al generated messages and anchors the message to the overall conversation flow.

In some implementations, the technology may use a choreographed sequence of events that provide non-verbal cues that indicate when a party is done talking. The result is a choreographed conversation that clearly communicates contents as well as conversational cues without distracting the user from their task.

For example, FIGS. 6A-6H illustrate a series of interfaces showing a choreography of a message from a copilot switching states from streaming to completed.

As illustrated in the examples, when control of the conversation is in the user's hands, the last message from the AI agent may be colored in, and the text input area may be in focus (e.g., in addition or alternative to changing background, the message area and/or message may be blurred).

The act of sending a message to the AI agent may be considered as conversational control being handed over to the AI agent. In some implementations, the input area may be disabled, which may indicate that the chat bot/Al agent has acknowledged receipt of the message from the user, as if to say, “I acknowledge what you just said, and I will respond now.” In some implementations, as the response is being generated by the AI agent, the chat interface may use low-contrast coloring that indicates the streaming-in-progress state, as if to say, “I'm currently speaking”.

Once the agent has completed its message, the chat interface engine 140 may hand back control of the conversation to the user using one or more operations, such as by recoloring the message block to indicate the change in state to streaming-completed, as if to say, “I'm done talking now”. In some implementations, it may additionally or alternatively bring focus to the text input box, prompting the user to respond, as if to say, “I would like to hear what you have to say about my response.”

FIG. 6A illustrates a first chat interface 600a in which a message area 610 is shown in a first state or format. For instance, this may be a first pending state or format in which the chat interface engine 140 indicates that it is waiting for a response from the other party. As illustrated in the example, the message area 610 may be in a format (e.g., with a slight transparency, lower contrast, a subtle border, and a first font color or boldness) where is different from the previously completed messages 602a, 602b, and 602c. For instance, this waiting state may be represented by a first border and/or background differentiating the message area 610 from the background 604, previously completed messages 602, and/or user messages 606a, 606b, and 606c.

For example, each message area for a waiting state (e.g., at 610 in FIG. 6A), a previously completed state (e.g., at 602a), a user message (e.g., 606), a streaming state (e.g., 610 in FIG. 6B), or a complete state (e.g., 610 in FIG. 6G) may have one or more differing formats to indicate the corresponding states.

The waiting state or message may be displayed in a message area 610 until streaming begins, although other implementations are possible and contemplated.

Additionally, as noted above, an input area 608 may be graphically deemphasized or deactivated.

The chat interface 600b of FIG. 6B illustrates an example update to the message area 610 in which text is being streamed from the other party (locally, via the Internet, etc.). As described in detail above, when the message is in a streaming state, the message area 610 may be displayed in a streaming format, which may reduce background, border, or other contrast from the chat interface background 604. For instance, immediately before the message starts streaming, the message area 610 may update to the streaming format. The transition between formats, including into and out of the streaming format, may be immediate or occur gradually (e.g., over 120 milliseconds).

As illustrated in the example of FIG. 6B, the streaming format may include a gradient of one or both of the background and border between opaque or partially opaque at a first (e.g., left) edge and moving toward more or completely transparent at a second (e.g., right) edge. As illustrated in the interface 600c of FIG. 6C, the message area 610 may expand vertically to fit the content as the message is streamed. As illustrated in interface 600d of FIG. 6D, the message area 610 may additionally or alternatively expand horizontally to fit the content as the message is streamed.

FIG. 6E illustrates an interface 600e in which the additional box 622 (e.g., a code block) has a background that is low contrast (e.g., transitioning between fully or partially opaque to transparent with the background of the message area 610) to the message area 610 and/or the chat interface 604. In some instances, the border of the additional box 622 has a gradient and/or is undefined at the right and/or bottom edge(s). In some instances, the border of the additional box 622 may extend fully or partially around the box 622 but may be subtle, thin, or transparent. Like the message area 610, when it transitions to a completed state, its background and/or border may change or increase in contrast (e.g., as illustrated in FIG. 6G).

FIG. 6F illustrates an interface 600f in which the additional box 622 being completely displayed; while the message area 610 is still in the streaming state (e.g., not yet fully generated, received, and/or displayed).

In the examples shown in these figures, the changes due to expansion are hidden at the transparent edge or background so that the visual jitteriness as the message area 610 and/or additional box 622 expand(s) is/are reduced. Additionally, as noted below, these figures illustrate interfaces that provide cues to differentiate between when the message is being streamed from when it is fully generated, received, and/or displayed.

FIG. 6G illustrates the message area 610 and/or additional box 622 in a completed state.

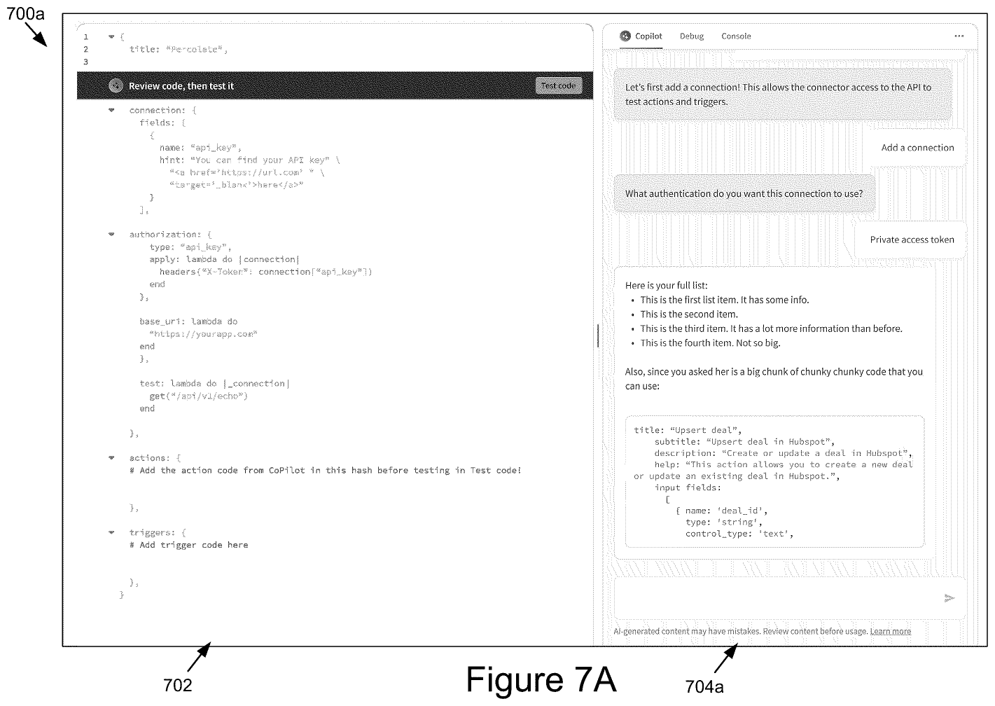

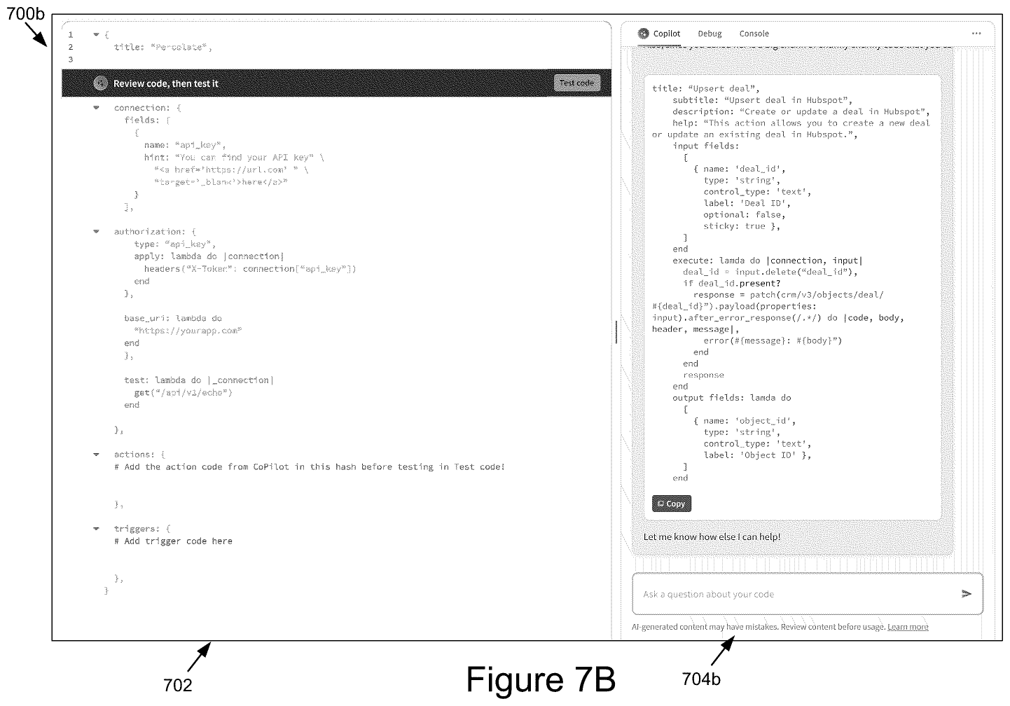

FIGS. 7A and 7B illustrate example graphical user interfaces 700a and 700b, which display a side bar or area that displays code as or when it is generated, for example, by the other party or artificial intelligence chat bot. For instance, the interface 700a illustrates a code section 702 and a chat section 704a. The code section 702 may display code as it is generated by a chat bot. This section 702 may be expanded in a similar way to the message area(s) described elsewhere herein or may be displayed based a user input or request. The chat section 704a illustrated in FIG. 7A may correspond to the example interface of FIG. 6E where there is a message area in a streaming state. The chat section 704b illustrated in FIG. 7B may correspond to th example interface of FIG. 6H.

It should be noted that although these changes are described in reference to the border and/or background, other changes or interface elements are possible.

For example, as illustrated in the interface 600g of FIG. 6G, the contrast between the message area 610 (and the additional box 622 for the additional media or text) is increased to differentiate it from the background 604 of the chat interface 600g. For example, a color, darkness, or pattern may be changed. Similarly, the border of the message area 610 (and/or the additional box 622) may be changed to make it uniform or completely enclose the area 610. For example, the border may be changed so that it is well defined everywhere or so that it is removed, although other changes are possible. This/these change(s) may illustrate that the message is complete.

In some implementations, when the message completes, the format of the message area 610 transitions from a streaming format to a complete format. This transition may happen instantly or gradually (e.g., over 240 milliseconds).

FIG. 6H illustrates a message area 610 in a complete state with an example complete format. As noted elsewhere herein, due to the limitations of line drawings, patterns and lines are illustrated, but gradients, colors, line weights, and other formatting tools may additionally or alternatively be used to differentiate the formats.

In some implementations, simultaneously, before, or after the transition of the format of the message area 610, the input area 608 may also be modified. For instance, the chat interface engine 140 may wait a defined time (e.g., 40 milliseconds), enable the input area/box 608, and change its format to emphasize it (e.g., instantly or gradually over a period of, for example, 80 milliseconds). For instance, a border of the input area 608 may be thickened or darkened, its background may change in color, pattern, opacity (e.g., from a partially transparent or matching color to the background 604), or it may otherwise be modified to draw attention to it. In some implementations, text may also be added to the input area 608 to indicate that it is available for input.

In the above description, for purposes of explanation, numerous specific details are set forth in order to provide a thorough understanding of the present disclosure. However, it should be understood that the technology described herein can be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services. Thus, it should be understood that a variety of different system environments and configurations are contemplated and are within the scope of the present disclosure. For instance, various functionality may be moved from a server to a client, or vice versa and some implementations may include additional or fewer computing devices, services, and/or networks, and may implement various functionality client or server-side. Further, various entities of the described system(s) may be integrated into to a single computing device or system or additional computing devices or systems, etc. In addition, while the system depicted herein provides an example of an applicable computing architecture, it should be understood that any suitable computing architecture, whether local, distributed, or both, may be utilized in the system.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various implementations described herein may relate to a computing device and/or other apparatus for performing the operations herein. This computing device may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of a hardware implementation, a software implementation, or implementations containing both hardware and software elements. For instance, the technology may be implemented in executable software, which includes but is not limited to an application, firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Communication unit(s) (e.g., network interfaces, etc.) may also be coupled to the system to enable the data processing system to become coupled to other data processing systems, storage devices, remote printers, etc., through intervening private and/or public networks, such as the network 102.

Wireless (e.g., Wi-Fi™) transceivers, Ethernet adapters, and modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats.

Furthermore, the modules, routines, features, attributes, methodologies and other aspects of the disclosure can be implemented as software, hardware, firmware, or any combination of the foregoing. Also, wherever a component, an example of which is a module, of the specification is implemented as software, the component can be implemented as a standalone program, as part of a larger program, as a collection of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment.

What is claimed is:

1. A computer-implemented method comprising:
providing, by one or more processors, a conversational graphical user interface for displaying messages between a user and an other party;
determining, by the one or more processors, that a first message from the other party is in a streaming state, the streaming state indicating that the first message is streaming to the user in the conversational graphical user interface;
displaying, by the one or more processors, the first message being streamed in a first message format based on the first message being in the streaming state;
determining, by the one or more processors, that the first message from the other party is in a complete state; and
displaying, by the one or more processors, the first message from the other party in a second message format based on the first message being in the complete state.

2. The computer-implemented method of claim 1, further comprising:
determining, by the one or more processors, one or more previously completed messages from the other party in the complete state; and
displaying, by the one or more processors in the conversational graphical user interface, the one or more previously completed messages from the other party in the first message format based on the one or more previously completed messages from the other party being in the complete state.

3. The computer-implemented method of claim 1, further comprising:
receiving, by the one or more processors, a first chat message from the user via the conversational graphical user interface; and
relaying, by the one or more processors, the first chat message to the other party, the other party including an artificial intelligence chat bot.

4. The computer-implemented method of claim 1, further comprising:
determining, by the one or more processors, a starting position in the conversational graphical user interface for the first message from the other party, the starting position indicating one or more of a first horizontal and a first vertical position for the first message in the conversational graphical user interface; and
determining, by the one or more processors, an ending position in the conversational graphical user interface for the first message, the ending position indicating one or more of a second horizontal and a second vertical position in the conversational graphical user interface corresponding to a maximum size of a message area from the other party.

5. The computer-implemented method of claim 4, further comprising:
providing, by the one or more processors, the message area in the conversational graphical user interface for the first message, the message area being visually defined from a background of the conversational graphical user interface at the starting position and being visually less defined from the background of the conversational graphical user interface at the ending position.

6. The computer-implemented method of claim 5, wherein:
the ending position changes as the first message is streamed and a dimension of the message area is based on the ending position in the conversational graphical user interface for the first message; and
the method includes increasing, by the one or more processors, a size of the message area in the conversational graphical user interface based on the starting position and the ending position as the first message is displayed.

7. The computer-implemented method of claim 4, wherein the first message format for the streaming state includes:
a contrast of the message area relative to a background of the conversational graphical user interface varying in a gradient between a first portion of the message area adjacent to the starting position and a second portion of the message area adjacent to the ending position; and
the message area including a border between the message area and the background adjacent to the starting position and no border between the message area and the background adjacent to the ending position before a completion time.

8. The computer-implemented method of claim 1, wherein:
the first message format for the first message in the streaming state includes:
a visible border along a left edge distinguishing a message area for the first message from a background of the conversational graphical user interface,
an invisible border along a right edge of the message area, and
a background of the message area along the right edge of the message area that matches the background of the conversational graphical user interface; and
the second message format for the first message in the complete state includes:
a visible border enclosing a perimeter of the message area, and
the background of the message area being visually distinguished from the background of the conversational graphical user interface.

9. The computer-implemented method of claim 1, further comprising:
determining, by the one or more processors, a completion time at which an end of the first message is displayed in the conversational graphical user interface; and
at the completion time, updating, by the one or more processors, the conversational graphical user interface to increase contrast between a message area of the first message and a background of the conversational graphical user interface.

10. The computer-implemented method of claim 1, further comprising:
providing, by the one or more processors, an input area in the conversational graphical user interface, the input area being configured to receive a user input from the user when the first message is in the complete state.

11. The computer-implemented method of claim 10, further comprising:
modifying, by the one or more processors, a visual format of the input area when the first message is in the streaming state including reducing a contrast of the input area from a background of the conversational graphical user interface.

12. The computer-implemented method of claim 11, further comprising:
preventing, by the one or more processors, text input from being entered into the input area when the first message is in the streaming state.

13. The computer-implemented method of claim 1, further comprising:
after displaying the first message in the second message format based on the first message being in the complete state, modifying, by the one or more processors, a visual attribute of an input area of the conversational graphical user interface, the visual attribute including an appearance of a border of the input area.

14. The computer-implemented method of claim 1, wherein:
the streaming state of the first message indicates that a portion of the first message is displayed pending display of a remainder of the first message.

15. A system comprising:
one or more processors; and
a non-transitory computer memory storing instructions that, when executed by the one or more processors cause the system to perform operations including:
providing a conversational graphical user interface for displaying messages between a user and an other party;
determining that a first message from the other party is in a streaming state, the streaming state indicating that the first message is streaming to the user in the conversational graphical user interface;
displaying the first message being streamed in a first message format based on the first message being in the streaming state;
determining that the first message from the other party is in a complete state; and
displaying the first message from the other party in a second message format based on the first message being in the complete state.

16. The system of claim 15, wherein the operations further comprise:
determining one or more previously completed messages from the other party in the complete state; and
displaying, in the conversational graphical user interface, the one or more previously completed messages from the other party in the first message format based on the one or more previously completed messages from the other party being in the complete state.

17. The system of claim 15, wherein the operations further comprise:
providing, by the one or more processors, a message area in the conversational graphical user interface for the first message, the message area being visually defined from a background of the conversational graphical user interface at a left edge and being visually less defined from the background of the conversational graphical user interface at a right edge.

18. The system of claim 15, wherein the first message format for the streaming state includes:
a contrast of a message area for the first message relative to a background of the conversational graphical user interface varying in a gradient between a first portion of the message area and a second portion of the message area; and
the message area including a border between the message area and the background adjacent to the first portion and no border between the message area and the background adjacent to the second portion before a completion time.

19. The system of claim 15, wherein the operations further comprise:
determining, by the one or more processors, a completion time at which an end of the first message is displayed in the conversational graphical user interface; and
at the completion time, updating, by the one or more processors, the conversational graphical user interface to increase contrast between a message area of the first message and a background of the conversational graphical user interface.

20. The system of claim 15, wherein the operations further comprise:
providing, by the one or more processors, an input area in the conversational graphical user interface, the input area being configured to receive a user input from the user when the first message is in the complete state;
modifying, by the one or more processors, a visual format of the input area when the first message is in the streaming state including reducing a contrast of the input area from a background of the conversational graphical user interface; and
preventing, by the one or more processors, text input from being entered into the input area when the first message is in the streaming state.
